(19) United States
(12) Patent Application Publication
(10) Pub. No.: US 2002/0196158 A1
(43) Pub. Date: Dec. 26, 2002

(54) Electric home appliance control system adapted to control an electric home appliance through an internet remote-controller

(76) Inventor: Chung-Wang Lee, Hsinchu (TW)

Correspondence Address: BACON & THOMAS, PLLC, 625 SLATERS LANE, FOURTH FLOOR, ALEXANDRIA, VA, 22314

(21) Appl. No.: 09/888,420

(22) Filed: Jun. 26, 2001

(51) Int. Cl. H04M 11/00; G08C 19/00

(52) U.S. Cl. 340/825.69; 379/102.01

(57) ABSTRACT

An electric home appliance control system using an Internet remote-controller to control the operation of an electric home appliance having an infrared receiver module and a control circuit, the Internet remote-controller including a network interface card connected to the Internet to receive a remote packet message sent by the user from the Internet, a CPU adapted to recognize the identification of the remote packet message received by the network interface card, an infrared transceiver module, and a network control circuit controlled by the CPU to produce a control signal and to let the control signal to be sent to the infrared receiver module of the electric home appliance by radio after receipt of the remote packet message from the Internet by the network interface card.

### BACKGROUND OF THE INVENTION

The present invention relates to an Internet information appliance control system and, more particularly to such an Internet information appliance control system, which comprises an Internet remote-controller connected to the Internet and adapted to output an infrared control signal for controlling an information apparatus upon receipt of a packet message sent by the user through the Internet.

Electric home appliances including TV, video tape recorder and player, VCD player, DVD player, air-conditioner, electric fan, and etc., have become requite products of our daily life for the advantages of versatile function and reasonable cost. These electric home appliances commonly have an infrared remote control circuit design, so that the user can control their operation by means of an infrared remote-controller. It is convenient to control different operation mode of an electric home appliance by means of a remote-controller. However, because conventional electric home appliances are independently operated and separately controlled, they are not connectable to the Internet to achieve a network control function. In the current electronic century, advanced electric home appliances are connectable to the Internet. These Internet electric home appliances are called IA (information appliances). By means of the Internet, the user can control the operation of the IA of the home from a remote place. However, these Internet information appliances are still not popularly accepted by consumers because of their high cost or, because most consumers already have similar conventional electric home appliances.

### SUMMARY OF THE INVENTION

The present invention has been accomplished under the circumstances in view. It is the main object of the present invention to provide an electric home appliance control system, which enables the user to control the operation of conventional electric home appliances having infrared receiver means at a remote place through the Internet.

According to one aspect of the present invention, the electric home appliance control system comprises an electric home appliance having an infrared receiver module and a control circuit, and an Internet remote-controller adapted to control the electric home appliance by means of a packet message sent by the user through the Internet. The Internet remote-controller sends an infrared control signal to the infrared receiver module of the electric home appliance upon receipt of a packet message from the Internet. Upon receipt of the control signal from the Internet remote-controller, the control circuit of the electric home appliance controls the operation of the electric home appliance subject to the nature of the control signal received from the Internet remote-controller through the infrared receiver module.

According to another aspect of the present invention, the Internet remote-controller comprises a CPU, which stops from processing the received packet message if the received packet message is not for controlling the corresponding electric home appliance.

According to another aspect of the present invention, the packet message is sent through the Internet to the Internet remote-controllers in all rooms of the user's house by means of broadcast packet. Upon receipt of the packet message, all the Internet remote-controllers in the user's house respectively recognize the nature of the packet message, so as to output or not to output an infrared control signal subject to the nature of the packet message. Therefore, the user can control the electric home appliance in either room of the house from a remote place through the Internet.

### BRIEF DESCRIPTION OF THE DRAWINGS

FIG. 1 is a system block diagram of an electric home appliance control system according to the present invention.

FIG. 2 is an operation flow chart of the present invention.

### DETAILED DESCRIPTION OF THE PREFERRED EMBODIMENT

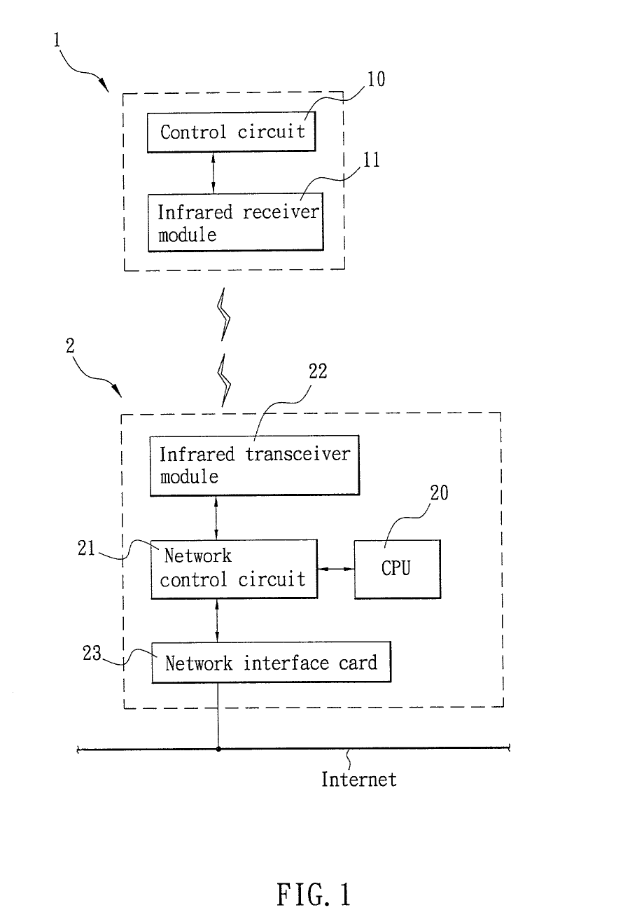

Referring to FIG. 1, an electric home appliance control system in accordance with the present invention comprises an Internet remote-controller 2 and an electric home appliance 1. The Internet remote-controller 2 is connected to the Internet to receive a control signal from the Internet, and then sends the control signal through the infrared transceiver module 22 thereof to the infrared receiver module 11 of the electric home appliance 1 set in the same room.

Referring to FIG. 1 again, in addition to the aforesaid infrared transceiver module 22, the Internet remote-controller 2 further comprises a CPU (central processing unit) 20, a network control circuit 21, and a network interface card 23. The CPU 20 controls the operation of the Internet remote-controller 2. The network control circuit 21 receives the signal from the network interface card 23, and is controlled by the CPU 20 to produce a control signal, enabling the produced control signal to be sent to the infrared receiver module 11 of the electric home appliance 1 through the infrared transceiver module 22 for controlling the operation of the electric home apparatus 1. In addition to the aforesaid infrared receiver module 11, the electric home appliance 1 further comprises a control circuit 10. By means of the network interface card 23, the Internet remote-controller 2 is connected to the Internet to receive the remote packet message. Upon receipt of the remote packet message from the Internet, the infrared receiver module 11 demodulates the received remote packet message, and then the control circuit 10 judges the nature of the received remote packet message. If the received remote packet message is recognized to be a control signal for controlling the electric home appliance 1, the control circuit 10 immediately receives and encodes the signal, so as to produce a corresponding infrared control signal.

The electric home appliance 1 can be a conventional electronic home appliance used with a conventional remote-controller. The infrared receiver module 11 receives the control signal from the Internet remote-controller 2 as well as the control signal from the matching remote-controller. The control circuit 10 of the electric home appliance 1 controls the operation of the electric home appliance 1 subject to the nature of the control signal received from the matching remote-controller of the electric home appliance 1 or the Internet remote-controller 2. Therefore, by means of the Internet remote-controller 2, the user can control the operation of the electric home appliance 1 from a remote place through the Internet.

Because the packet message from the Internet is of broadcast packet message, multiple Internet remote-controllers 2 in all rooms in the user's house can simultaneously receive the packet message from the Internet. If the received packet message is not to control the corresponding electric home appliance 1 in the same room of the house, the CPU 20 does not process the received packet message. The CPU 20 processes the received packet message only when the received packet message is recognized to be for controlling the corresponding electric home appliance 1 in the same room of the house. Therefore, the user can install an Internet remote-controller 2 in each room of the house to control a corresponding electric home appliance 1 in the same room of the house.

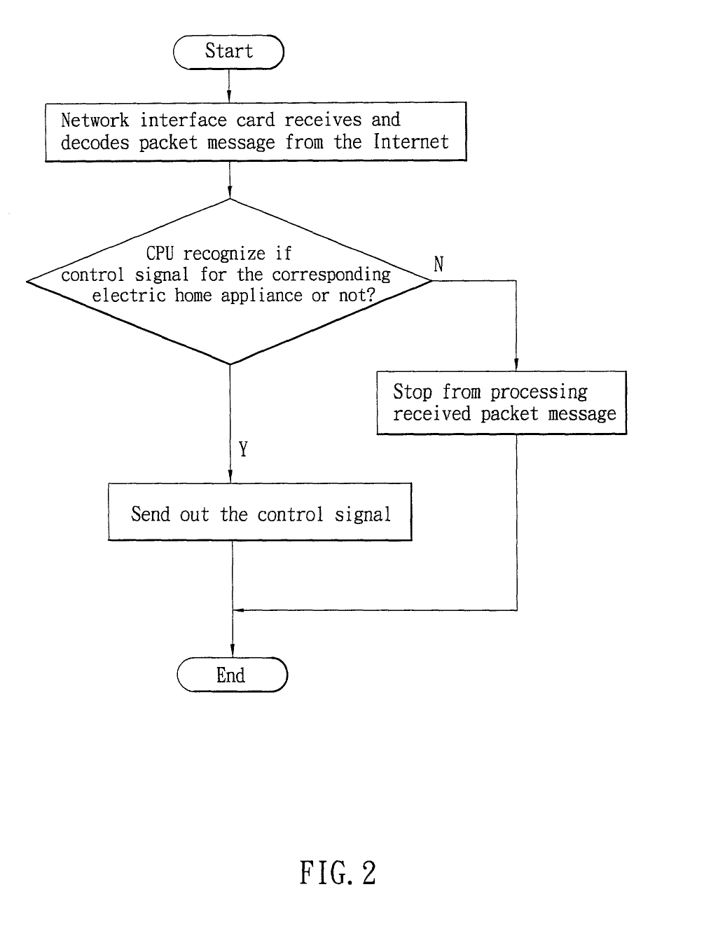

Referring to FIG. 2 and FIG. 1 again, the operation flow of the present invention is outlined hereinafter.

(1) At first, the network interface card 23 decodes the packet message upon receipt of same from the Internet;

(2) The CPU 20 judges if the decoded packet message is adapted to control the operation of the corresponding information appliance or not, and then drives the network control circuit 21 to produce a corresponding control signal and the infrared transceiver module 22 to send out the control signal from the network control circuit 21 by radio if positive, or to proceed to the following next step if negative;

(3) The CPU 20 stops from processing the received packet message if the received packet message is not adapted to control the corresponding electric home appliance 1 in the same room of the house.

A prototype of Internet information appliance control system has been constructed with the features of FIG. 1. The Internet information appliance control system functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An electric home appliance control system comprising at least one electric home appliance having an infrared receiver module and a control circuit and at least one Internet remote-controller adapted to control said at least one electric home appliance respectively, said at least one Internet remote-controller each comprising a network interface card connected to the Internet and adapted to receive a remote packet message from the Internet, a CPU (central processing unit) adapted to recognize the identification of the remote packet message received by said network interface card, a network control circuit controlled by said CPU to produce a control signal after receipt of a remote packet message from the Internet by said network interface card and recognition of the received remote packet message by said CPU, and an infrared transceiver module controlled by said CPU to send out the control signal from said network control circuit by radio, for enabling the control signal to be received by the infrared receiver module of the corresponding electric home appliance and the control circuit of the corresponding electric home appliance to control the operation of the corresponding electric home appliance subject to the nature of the control circuit.

2. The electric home appliance control system of claim 1 wherein said CPU stops from processing the received remote packet message if the received remote packet message is not for controlling the corresponding information appliance.

3. The electric home appliance control system of claim 1 wherein said remote packet message from the Internet is a broadcast packet.
